(19) United States
(12) Patent Application Publication
(10) Pub. No.: US 2008/0183564 A1
(43) Pub. Date: Jul. 31, 2008

(54) Untethered Interaction With Aggregated Metrics

(75) Inventors: Ian Tien, Seattle, WA (US); Corey J. Hulen, Sammamish, WA (US); Chen-I Lim, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/668,763

(22) Filed: Jan. 30, 2007

(51) Int. Cl. G06F 9/44

(52) U.S. Cl. 705/11

(57) ABSTRACT

Untethered interaction with a performance metric application in a service-based architecture is provided enabling users to have access to an enterprise library of summarized metrics and metric views in wireless environments. Metric data, aggregations, and analyses are provided to local application(s) for rendering personalized and scalable views. Through caching and synchronization, offline operations are enabled. Permission levels, user profiles, and multi-tiered security measures ensure protection of confidentiality and integrity of performance metric data.

### BACKGROUND

Key Performance Indicators (KPIs) are quantifiable measurements that reflect the critical success factors of an organization ranging from income that comes from return customers to percentage of customer calls answered in the first minute. Key Performance Indicators may also be used to measure performance in other types of organizations such as schools, social service organizations, and the like. Measures employed as KPI within an organization may include a variety of types such as revenue in currency, growth or decrease of a measure in percentage, actual values of a measurable quantity, and the like.

Solutions available for addressing the needs of end-users in the business intelligence space are limited. There are few accessible means for end-users to reach the data they need to make critical business decisions when away from “tethered” technology on laptops and desktop computers. Without easy-to-find, real-time visibility into key metrics such as resource hours available, budget remaining, product inventory, and other data, end-users are at risk of expensive errors, compliance violations, and failure to deliver.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to providing access to an enterprise library of summarized metrics and metric views in untethered environments. Interaction with metric data, aggregations, and analyses; personalization; collaboration; and metric based alerting are enabled through secure connectivity.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an example scorecard architecture;

FIG. 2 illustrates a screenshot of an example scorecard;

FIG. 3 illustrates a screenshot of an example scorecard application user interface;

FIG. 4 illustrates a screenshot of another example scorecard application user interface;

FIG. 5 illustrates screenshots of two example mobile device application user interfaces for performance metrics;

FIG. 6 illustrates a screenshot of an indicator selection wizard for a mobile device performance metrics application;

FIG. 7 illustrates an example service-based architecture in which the untethered interaction with performance metric applications may be performed;

FIG. 8 is a diagram of a networked environment where embodiments may be implemented;

FIG. 9 is a block diagram of an example computing operating environment, where embodiments may be implemented; and

FIG. 10 illustrates a logic flow diagram for a process of untethered interaction with a performance metric application in a service-based architecture.

### DETAILED DESCRIPTION

As briefly described above, users are enabled to interact with an enterprise library of summarized metrics and metric views in untethered environments. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

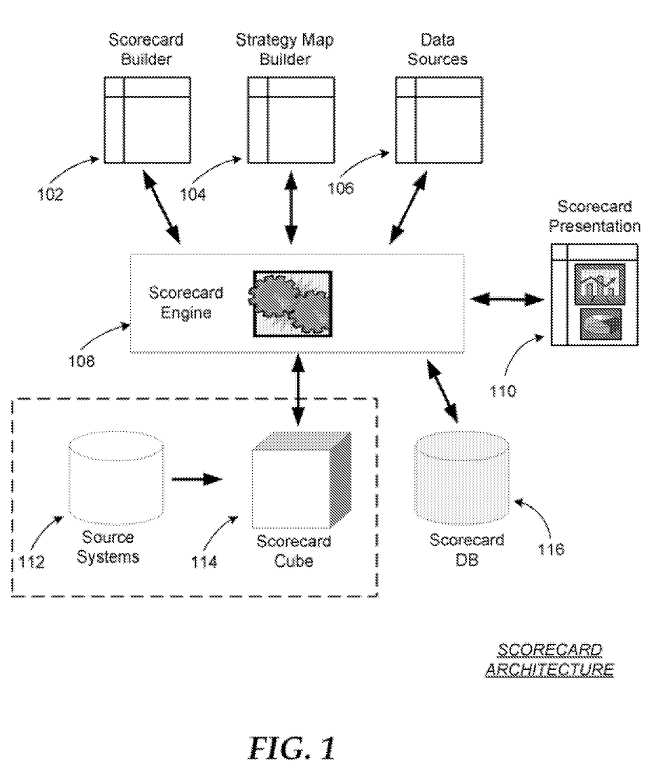

Referring to FIG. 1, an example scorecard architecture is illustrated. The scorecard architecture may comprise any topology of processing systems, storage systems, source systems, and configuration systems. The scorecard architecture may also have a static or dynamic topology.

Scorecards are an easy method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture, a core of the system is scorecard engine 108. Scorecard engine 108 may be an application software that is arranged to evaluate performance metrics. Scorecard engine 108 may be loaded into a server, executed over a distributed network, executed in a client device, and the like.

Data for evaluating various measures may be provided by a data source. The data source may include source systems 112, which provide data to a scorecard cube 114. Source systems 112 may include multi-dimensional databases such OLAP, other databases, individual files, and the like, that provide raw data for generation of scorecards. Scorecard cube 114 is a multi-dimensional database for storing data to be used in determining Key Performance Indicators (KPIs) as well as generated scorecards themselves. As discussed above, the multi-dimensional nature of scorecard cube 114 enables storage, use, and presentation of data over multiple dimensions such as compound performance indicators for different geographic areas, organizational groups, or even for different time intervals. Scorecard cube 114 has a bi-directional interaction with scorecard engine 108 providing and receiving raw data as well as generated scorecards.

Scorecard database 116 is arranged to operate in a similar manner to scorecard cube 114. In one embodiment, scorecard database 116 may be an external database providing redundant back-up database service.

Scorecard builder 102 may be a separate application or a part of a business logic application such as the performance evaluation application, and the like. Scorecard builder 102 is employed to configure various parameters of scorecard engine 108 such as scorecard elements, default values for actuals, targets, and the like. Scorecard builder 102 may include a user interface such as a web service, a GUI, and the like.

Strategy map builder 104 is employed for a later stage in scorecard generation process. As explained below, scores for KPIs and other metrics may be presented to a user in form of a strategy map. Strategy map builder 104 may include a user interface for selecting graphical formats, indicator elements, and other graphical parameters of the presentation.

Data Sources 106 may be another source for providing raw data to scorecard engine 108. Data sources 106 may also define KPI mappings and other associated data.

Additionally, the scorecard architecture may include scorecard presentation 110. This may be an application to deploy scorecards, customize views, coordinate distribution of scorecard data, and process web-specific applications associated with the performance evaluation process. For example, scorecard presentation 110 may include a web-based printing system, an email distribution system, and the like. In some embodiments, scorecard presentation 110 may be an interface that is used as part of the scorecard engine to export data and/or views to a mobile applications enabling visualizations of performance metrics on limited displays.

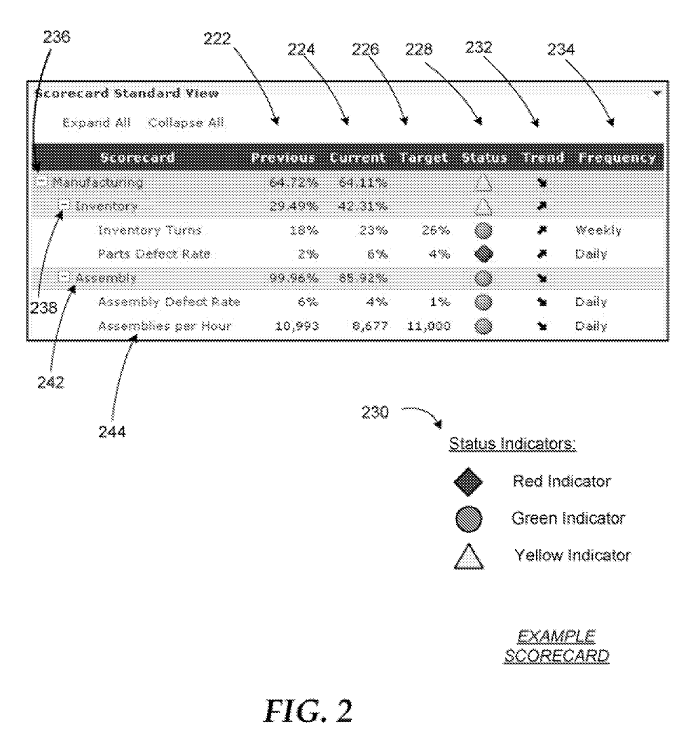

FIG. 2 illustrates a screenshot of an example scorecard with status indicators 230. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. This may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The arrows displayed in the scorecard of FIG. 2 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent metric.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of the scorecard shows example top level metric 236 “Manufacturing” with its reporting KPIs 238 and 242 “Inventory” and “Assembly”. Second column 222 in the scorecard shows results for each measure from a previous measurement period. Third column 224 shows results for the same measures for the current measurement period. In one embodiment, the measurement period may include a month, a quarter, a tax year, a calendar year, and the like.

Fourth column 226 includes target values for specified KPIs on the scorecard. Target values may be retrieved from a database, entered by a user, and the like. Column 228 of the scorecard shows status indicators 230.

Status indicators 230 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Other types of indicators may also be employed to provide status feedback. For example, indicators with more than three levels may appear as a bar divided into sections, or bands. Column 232 includes trend type arrows as explained above under KPI attributes. Column 234 shows another KPI attribute, frequency.

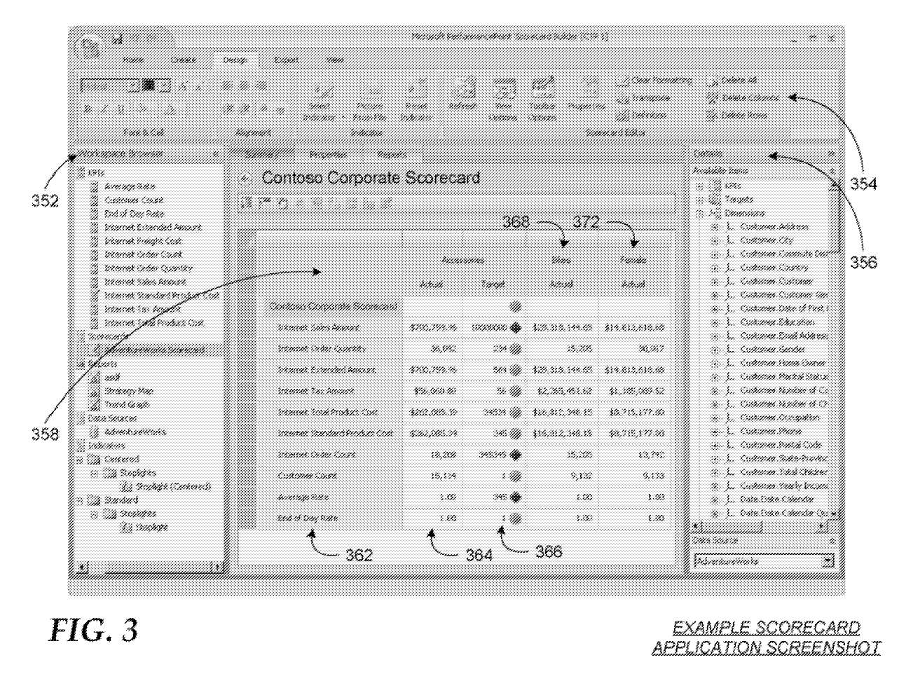

FIG. 3 is a screenshot of an example scorecard application with an example scorecard. The example scorecard application may be part of a business logic service that collects, processes, and analyzes performance data from various aspects of an organization.

The user interface of the scorecard application as shown in the screenshot include controls 354 for performing actions such as formatting of data, view options, actions on the presented information, and the like. The main portion of the user interface displays scorecard 358 “Contoso Corporate Scorecard”. The scorecard includes metrics such as “Internet Sales Amount”, “Internet Order Quantity”, “Customer Count”, and the like in column 362. Columns 364 and 366 respectively display actuals and targets for the category of “Accessories” for each of the listed metrics. Columns 368 and 372 display the actuals for the categories “Bikes” and “Female” (referring to female bikes).

Side panel 352 titled “Workspace Browser” provides a selection of available KPIs as well as elements of the scorecard such indicators and reports that are associated with the selected scorecard. Other side panel 356 provides additional details about available scorecard elements such as a collapsible list of KPIs, targets, and dimension combinations. A scorecard application, as discussed in further detail below, may include additional aspects of the scorecard such as different visualizations, linked information (geography, time and date, contact information, etc.), commentary, and so on.

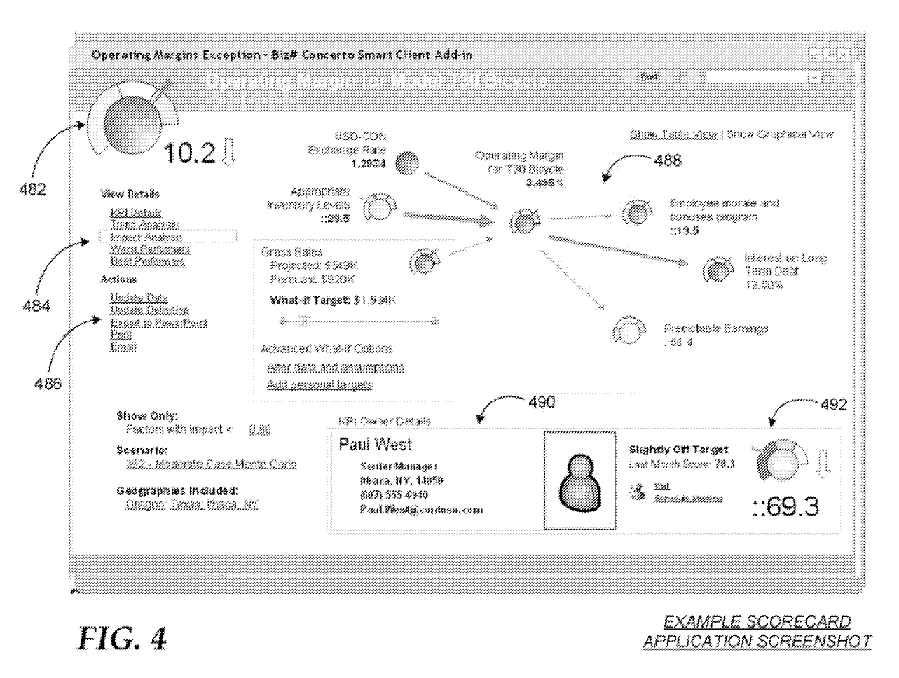

FIG. 4 illustrates a screenshot of another example scorecard application user interface. Scorecard application user interfaces may include various visualizations of metric data and controls associated with performance metric computations. In the second example user interface screenshot, composite gauge 482 provides information associated with “operating margin for Model T30 bicycle”. The gauge is complemented by numeric display of change in the metric and a down arrow indicating the trend of the metric.

Diagram 488 in the center of the user interface shows relationships between different metrics such as metrics that report to the “operating margin for Model T30 bicycle” metric and metrics to which “operating margin for Model T30 bicycle” reports. Each metric is displayed with a gauge and numeric information conveying its status.

View details 484 provide options to a user for selecting different analysis and report types. Actions section 486 provides options for various user actions such as printing, emailing, updating data, and so on associated with the metric in view.

Panel 490 of the user interface provides details about the metric owner (e.g. contact information), as well as metric view 492 displaying status of the metric with the previous period's score.

According to some embodiments, data and/or views of portions of the presented metric may be provided to an application on an untethered device for personalized and scalable interaction of a user with the business service managing the metric.

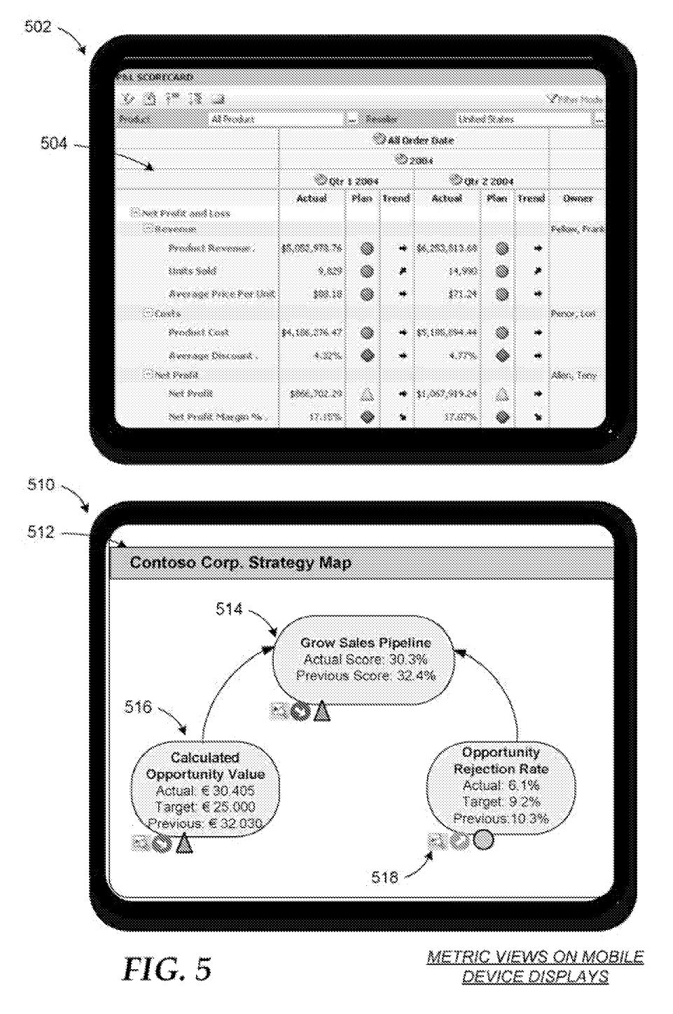

FIG. 5 illustrates screenshots of two example mobile device application user interfaces for performance metrics. Through secure connectivity, applications in untethered devices are enabled to provide rich data interaction and drilldown for root cause-analysis, investigation, and rapid reporting to users according to embodiments. The ability to personalize view and alerting levels on key aggregated metrics enables users to make faster, more relevant decisions while working in untethered environments.

First example user interface 502 shows a partial scorecard view 504 with the aggregated metrics and their hierarchy, actuals, targets, status indicators, and trends. As described above, a user interface of a full-capacity scorecard application typically includes a number of controls and elements conveying significant amounts of information to the user and enabling the user to interact with various aspects of performance metric computation. On the other hand, applications on untethered devices (e.g. mobile devices) may be used to convey limited information associated with selected aspects of performance metrics.

Despite potential limitations of applications on untethered devices, a number of controls such as interaction with the business service through selection of distinct scorecard elements may still be provided. These may include activation of report views in response to selection of metrics, statistical analyses, activation of associated applications such as email, instant messaging, printing, and so on. Furthermore, due to the nature of untethered communications, update of data may be configured to enable offline operations, synchronization upon reconnection, security mechanisms, and the like. Second user interface 510 illustrates an example strategy map detail with composite objects. Composite objects may be employed in performance metric data based presentations in various ways. The strategy map 512 includes two levels of objectives with two objectives reporting to objective 5104 on a higher level. Elliptic geometric shapes are used to represent the objectives with textual information provided within the objects. The textual information includes a description of each objective, actual and target values for each objective and previous actuals for each objective. The metric data in the presentation may be connected to the computation engine such that any changes in the underlying data can be reflected by updating the objects. Updates may be performed periodically, upon request by the untethered device (pull), or upon transmission by the computation engine (push). Moreover, a capability of the computation engine to work with a diversity of data (currency, percentage, etc.) and still compute statuses is also reflected in the presentation by showing the metric data in their original format (e.g. euro, percentage).

Also included in the presentation are smaller composite objects or icons (e.g. 518) for further status indication. These include trend icons, status indicators according to a selected scheme, and so on. By using composite objects as opposed to bitmap images or other types of data inherent limitations of these types of objects are overcome providing a dynamic link between the presentation and the performance metric computation.

As in the first example user interface, interaction with the computation engine or other parts of the business service managing the operations may be provided through selection of any of the objects on the metric view, menu items in the user interface, and the like.

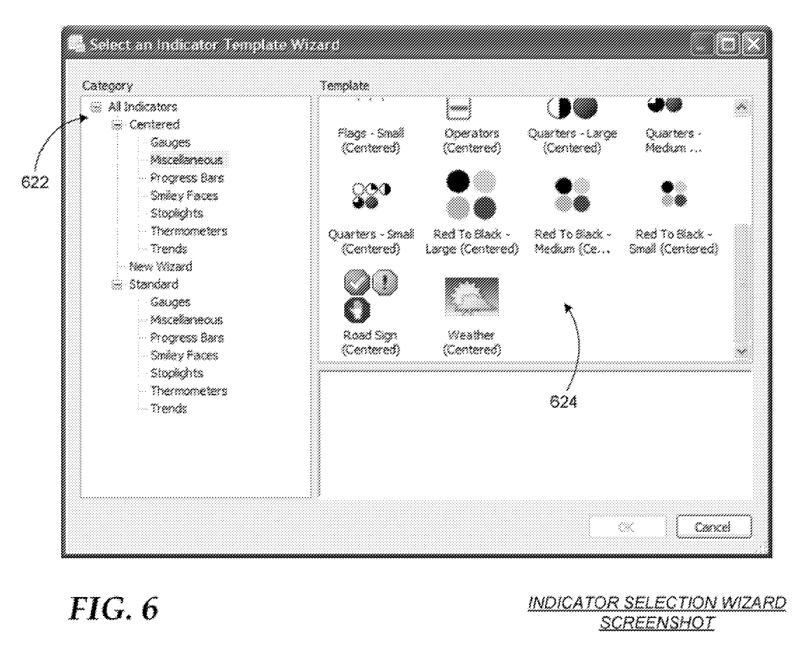

FIG. 6 illustrates a screenshot of an indicator selection wizard for a mobile device performance metrics application. Metric views may be provided in untethered visualization applications according to embodiments with preselected indicators representing metrics or analysis results. According to other embodiments, the user may be enabled to select one or more indicators to be used by the visualization application and define scorecard elements (and/or analysis results) to be reflected by the selected indicators. The indicator selection wizard is one method of implementing such a selection.

Category panel 622 lists available indicators by category in a collapsible list format. The list of available indicators may also be provide using other formats. In the example screenshot, “Miscellaneous” category is selected under the main group of Centered Indicators.

Template panel 624 includes visual representations of available indicators in this category. The indicators include circled flags, pie chart icons (quarters), color scheme dots, road signs, and the like. Visualization applications in untethered devices may include single or multiple indicators. The indicators employ geometric units to visualize business performance and show magnitude, patterns of structured and unstructured data, interrelationships, causalities, and dependencies. Through visualizing outputs of quantitative models business users may be enabled to make faster, more relevant decisions based on data that is readily interpreted. The example indicator selection wizard may be part of an embeddable authoring user interface for generating performance metric based visualizations. For example, the wizard may provide a selection of objects from a graphics application such as VISIO® by MICROSOFT CORP. of Redmond, Wash.

Other example indicators may include bar indicators, traffic light indicators, check marks, smiley faces, and so on, which utilize shape and color to convey performance metric information to the user.

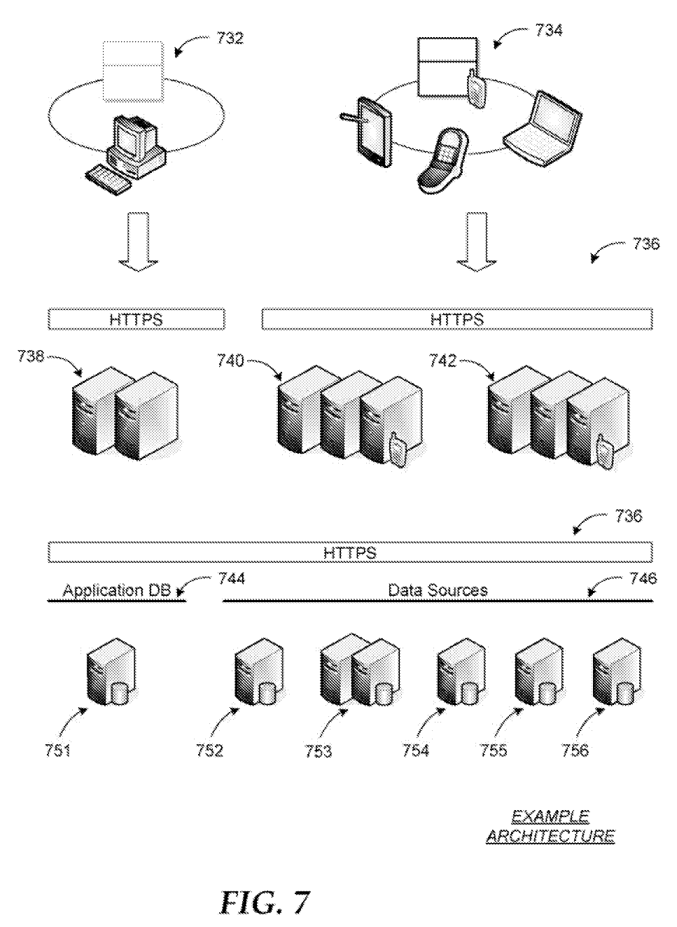

FIG. 7 illustrates an example service-based architecture in which the untethered interaction with performance metric applications may be performed. Service based architectures are an increasingly popular style for building software applications that use services available in a network such as the web. They promote loose coupling between software components so that they can be reused. Applications in a service based architecture are built based on services. A service is an implementation of a well-defined business functionality, and such services can then be consumed by clients in different applications or business processes.

A service based architecture allows for the reuse of existing assets where new services can be created from an existing infrastructure of systems. In other words, it enables businesses to leverage existing investments by allowing them to reuse existing applications, and promises interoperability between heterogeneous applications and technologies. Service based architectures provide a level of flexibility in the sense that services are software components with well-defined interfaces that are implementation-independent. An important aspect of service based architecture is the separation of the service interface from its implementation. Such services are consumed by clients that are not concerned with how these services will execute their requests. Services are commonly self-contained (perform predetermined tasks) and loosely coupled. Furthermore, services can be dynamically discovered, and composite services can be built from aggregates of other services.

A service based architecture uses a find-bind-execute paradigm. In this paradigm, service providers register their service in a public registry. This registry is used by consumers to find services that match certain criteria. If the registry has such a service, it provides the consumer with a contract and an endpoint address for that service. Service based applications are typically distributed multi-tier applications that have presentation, business logic, and persistence layers. Services are the building blocks of service based applications.

In FIG. 7, data associated with performance metric calculations may be stored and provided by scorecard database(s) 744 managed by scorecard database server 751. Scorecard database server 751 may manage exchange of scorecard data based granular, role based permissions. Source data for metric calculations and statistical analyses may be provided by data sources 746.

Data sources 746 may include business models database server 852, analysis services database server(s) 753, tables server 754, lists server 755, files server 856 (e.g. text files, spreadsheet files, and the like), and so on. The data sources may be managed by one or more servers of any type discussed herein. The scorecard database server and data source servers may communicate with servers managing performance metric services through a secure network communication protocol such as HTTPS 736.

Performance metric services may include scorecard service managed by scorecard server(s) 738. Scorecard server(s) 738 may also provide web services. Reporting services may be provided by one or more reporting servers 740. Reporting services may include providing results of statistical analyses, performance metric computations, presentations, and the like in various formats based on subscriber permissions, profiles, client devices, and client applications. According to an example embodiment, reporting servers may be enabled to provide untethered connectivity such as wireless networking (e.g. WiFi system, cellular system, and so on) and provide performance metric data and objects to one or more applications installed on a user's untethered device.

Moreover, shared services servers 742 may manage shared services that enable individual users to access the scorecard services, presentations, and data through client devices 734. Client devices 734 may include specialized applications or web applications to facilitate untethered communication through a secure protocol such as HTTPS 736.

Scorecard computations may also be performed in coordination with scorecard server(s) 738 by a client application on client device 732 communicating with the scorecard servers through HTTPS 736. As illustrated by reporting servers 740 and shared services servers 742, some or all of the servers at different levels of the architecture may support web farming.

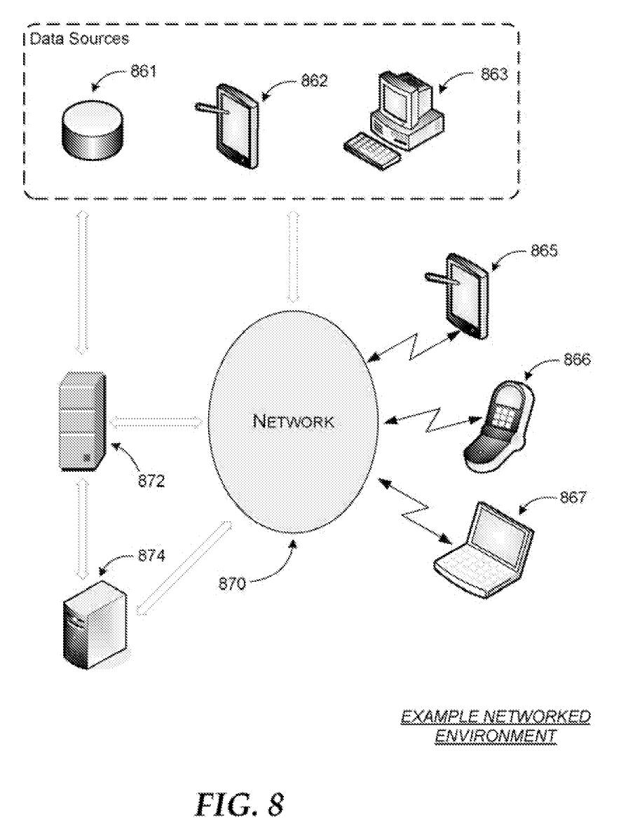

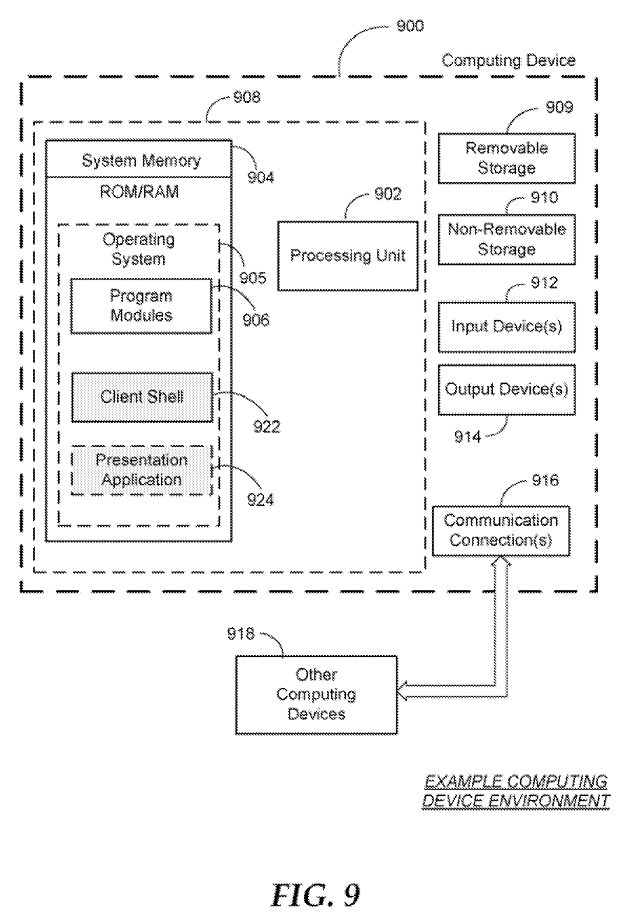

Referring now to the following figures, aspects and exemplary operating environments will be described. FIG. 8, FIG. 9, and the associated discussion are intended to provide a brief, general description of a suitable computing environment in which embodiments may be implemented.

FIG. 8 is a diagram of a networked environment where embodiments may be implemented. The system may comprise any topology of servers, clients, Internet service providers, and communication media. Also, the system may have a static or dynamic topology. The term “client” may refer to a client application or a client device employed by a user to perform operations associated with rendering performance metric data using geometric objects. While a networked business logic system may involve many more components, relevant ones are discussed in conjunction with this figure.

In a typical operation according to embodiments, business logic service may be provided centrally from server 872 or in a distributed manner over several servers (e.g. servers 872 and 874) and/or client devices. Server 872 may include implementation of a number of information systems such as performance measures, business scorecards, and exception reporting. A number of organization-specific applications including, but not limited to, financial reporting/analysis, booking, marketing analysis, customer service, and manufacturing planning applications may also be configured, deployed, and shared in the networked system.

Data sources 861-863 are examples of a number of data sources that may provide input to server 872. Additional data sources may include SQL servers, databases, non multi-dimensional data sources such as text files or EXCEL® sheets, multi-dimensional data source such as data cubes, and the like.

Users may interact with the server running the business logic service from untethered client devices 865-867 over network 870. Users may also directly access the data from server 872 and perform analysis on their own machines. In some embodiments, users may set up personalized visualization applications displayed on the client devices 865-867 that receive data (and/or views) from the business logic service and provide scalable views of metrics.

Client devices 865-867 or servers 872 and 874 may be in communications with additional client devices or additional servers over network 870. Network 870 may include a secure network such as an enterprise network, an unsecure network such as a wireless open network, or the Internet. Network 870 provides communication between the nodes described herein. By way of example, and not limitation, network 870 may include wired media such as a wired network or direct-wired connection, and wireless media such as acoustic, RF, infrared and other wireless media.

Many other configurations of computing devices, applications, data sources, data distribution and analysis systems may be employed to implement providing interaction with a performance metric service in an untethered environment. Furthermore, the networked environments discussed in FIG. 8 are for illustration purposes only. Embodiments are not limited to the example applications, modules, or processes. A networked environment for may be provided in many other ways using the principles described herein.

With reference to FIG. 9, a block diagram of an example computing operating environment is illustrated, such as computing device 900. In a basic configuration, the computing device 900 is an untethered device communicating with the performance metric service via RF, infrared, or other wireless means, and typically includes at least one processing unit 902 and system memory 904. Computing device 900 may include a plurality of processing units that cooperate in executing programs. Depending on the exact configuration and type of computing device, the system memory 904 may be volatile (such as RAM), non-volatile (such as ROM, flash memory, etc.) or some combination of the two. System memory 904 typically includes an operating system 905 suitable for controlling the operation of a networked personal computer, such as the WINDOWS®operating systems from MICROSOFT CORPORATION of Redmond, Wash. The system memory 904 may also include one or more software applications such as program modules 906, client shell 922, and optional presentation application 924.

Client shell 922 may be any application that processes and generates scorecards and associated data in conjunction with a performance metric service receiving modules, data, objects, and so on from the service. Optional presentation application 924 may provide presentations of aspects of the performance metric computations based on data from client shell 922 or the performance metric service. Presentation application 924 or client shell 922 may be executed in an operating system other than operating system 905. This basic configuration is illustrated in FIG. 9 by those components within dashed line 908.

The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by removable storage 909 and non-removable storage 910. Computer storage media may include volatile and nonvolatile, removable and non-removable media implemented in any method or technology for storage of information, such as computer readable instructions, data structures, program modules, or other data. System memory 904, removable storage 909 and non-removable storage 99 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media may be part of device 900. Computing device 900 may also have input device(s) 912 such as keyboard, mouse, pen, voice input device, touch input device, etc. Output device(s) 914 such as a display, speakers, printer, etc. may also be included. These devices are well known in the art and need not be discussed at length here.

The computing device 900 may also contain communication connections 916 that allow the device to communicate with other computing devices 918, such as over a wireless network in a distributed computing environment, for example, an intranet or the Internet. Communication connection 916 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

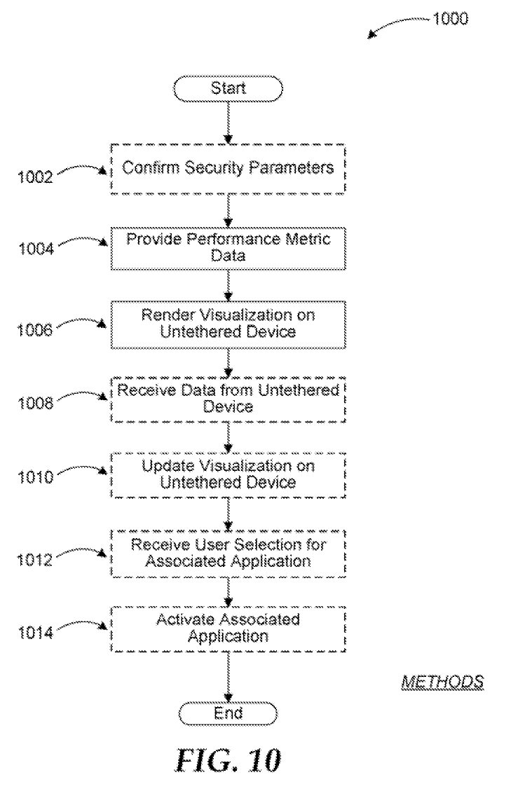

FIG. 10 illustrates a logic flow diagram for a process of untethered interaction with a performance metric application in a service-based architecture. Process 1000 may be implemented in a service architecture based business logic service.

Process 1000 begins with operation 1002, where security parameters for a performance metric application on an untethered device are confirmed. In addition to typical security checks such as user password entry, network communication status check, further security measures such as secondary password protection, time and/or location (using GPS locators) based security measures may also be implemented to protect the confidentiality and integrity of performance metric data and views managed by the business logic service. Processing advances from operation 1002 to operation 1004.

At operation 1004, performance metric data and/or report views are provided by the business service to the application enabling it to render scorecard views, report views, perform or present statistical analyses, and the like. Processing proceeds from operation 1004 to operation 1006.

At operation 1006, a visualization associated with the scorecard is rendered. As described above, visualizations may include full or partial scorecard views, report views for selected elements, statistical analysis results, and the like. Visualization may further include associated information such as contact information for metric owners, commentary, annotations, source data, video or audio feeds, and the like. Processing moves from operation 1006 to optional operation 1008.

At optional operation 1008, data is received from the untethered device. A user may perform computations using the performance metric application on the untethered device, provide input data, or make modifications on portions of the performance metric data used by the business service. After security and integrity of the received data is verified, the business service may incorporate the data to its data stores and update computations and reports based on the data. Processing advances to optional operation 1010 from optional operation 1008.

At optional operation 1010, the visualization on the untethered device is updated based on a change of data or computations managed by the business service. Updating of the visualization and data provided to the application on the untethered device may be performed periodically, in response to a request by the application, or in response to a change by the business service. The data provided to the untethered device may also be cached for offline operations and synchronized upon reconnect subject to security checks. Processing advances to optional operation 1012 from optional operation 1010.

At optional operation 1012, a user selection for an associated application is received. The user selection may be the user clicking on a portion of the visualization, selecting a checkbox, a radio button, or any other icon. The selection may also include the user clicking on a portion of a rendered view (e.g. a partial scorecard view). The associated application may include a communication application for collaboration on the scorecard, a presentation application for rendering a report view, an analysis application for statistical analysis, a data storage application for retrieving or storing data, and the like. Processing advances to optional operation 1014 from optional operation 1012.

At optional operation 1014, the associated application is activated in response to the user selection. The associated application may be a local application or a remote application managed by the hosted business service. After operation 1014, processing moves to a calling process for further actions.

The operations included in process 1000 are for illustration purposes. Untethered interaction with a performance metric application in a service-based architecture may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for interacting with a hosted business service providing performance metric operations in an untethered environment, the method comprising:
providing performance metric data to an application on an untethered device from a hosted business service, wherein the hosted business service manages the performance metric data and computations associated with the performance metric data; and
enabling the application to provide a user interface for at least one from a set of: viewing a portion of the performance metric data, viewing a report based on the performance metric data, and providing a feedback to the hosted business service.

2. The method of claim 1, wherein the user interface is also configured to provide access to at least one from a set of: a communication application for collaboration on the scorecard, a presentation application for rendering a report view, an analysis application for statistical analysis, and a data storage application for retrieving or storing data.

3. The method of claim 1, further comprising:
prior to providing the performance metric data, performing a security check based on at least one from a set of: a user permission, a user profile, a network connection status, a password verification, a temporal verification, and a geographic verification.

4. The method of claim 1, further comprising:
enabling the performance metric data to be cached at the untethered device for offline operations.

5. The method of claim 4, further comprising:
synchronizing the performance metric data at the untethered device with the data managed by the hosted business service upon reconnect.

6. The method of claim 4, further comprising:
enabling the cached data at the untethered device to be deleted in response to at least one of a predefined security condition and an expiration of a predetermined period.

7. The method of claim 1, further comprising:
prioritizing a data request from the hosted business service based on a hierarchical representation of a scorecard such that an rendered summary information following an aborted data transfer is maximized; and
enabling recovery from a lost data transfer without the untethered device having to re-request successfully received fragments of a message.

8. The method of claim 1, further comprising:
updating the performance metric data at the untethered device in response to at least one of: expiration of a predetermined period, a change to the performance metric data at the hosted business service, and a request by the application on the untethered device.

9. The method of claim 1, wherein the application is a client shell receiving parameters from the hosted business service, and wherein the application is enabled to receive a plurality of plug-ins.

10. The method of claim 1, further comprising:
adjusting a view associated with one of: a portion of the performance metric data and a report based on a display capability of the application on the untethered device.

11. The method of claim 1, further comprising:
enabling the application to receive performance metric data from a plurality of service providers; and
partitioning the service providers for performance metric services using virtualized instances.

12. The method of claim 1, wherein the application is enabled to receive live data feeds, and the application is configured to perform aggregation of performance metrics based on dependent data feeds.

13. The method of claim 1, wherein the application is an embeddable application that is embedded into a desktop application on the untethered device.

14. A system for interacting with a business service providing performance metric operations in an untethered environment, the system comprising:
a memory;
a processor coupled to the memory, wherein the processor is configured to execute instructions to perform actions including:
configure at least one parameter of an application on an untethered device based on one of a user input and a predefined user profile;
authorize data delivery to the application based on a confirmation of a security status of the application;
provide performance metric data to the application from a hosted business service, wherein the hosted business service manages the performance metric data and computations associated with the performance metric data; and
enable the application to provide a user interface for at least one from a set of: viewing a portion of the performance metric data, viewing a report based on the performance metric data, and providing a feedback to the hosted business service.

15. The system of claim 14, wherein the application is enabled to provide a visualization of the provided performance metric data by mapping attributes of the performance metric data to at least one from a set of: a size, a rotation, a background color, a foreground color, an outline color, an outline thickness, a position of objects provided by the hosted business service.

16. The system of claim 14, wherein the processor is further configured to automatically provide at least one of a service update and a security update to the application.

17. The system of claim 14, wherein the processor is further configured to provide a library of plug-in modules, objects, and report views to the application based on at least one from a set of: a user profile, a user permission level, and a predefined configuration.

18. A computer-readable storage medium with instructions stored thereon for interacting with a business service providing performance metric operations in an untethered environment, the instructions comprising:
configuring a visualization application on an untethered device at least in part based on a user input;
registering the visualization application with a hosted business service;
providing performance metric data to the visualization application from the hosted business service managing the performance metric data and computations associated with the performance metric data;
enabling caching of the performance metric data at the untethered device;
enabling the application to render a visualization based on a portion of the performance metric data, the visualization including at least one from a set of: a report, a presentation, the portion of the performance metric data, commentary on the portion of the performance metric data, and information associated with performance metric owners;
enabling the application to provide feedback to the hosted business service in response to a user action; and
activating another application associated with the provided performance metric data in response to receiving a user selection through the application on the untethered device.

19. The computer-readable storage medium of claim 18, wherein the other application is one of a local application residing on the untethered device and a remote application managed by the hosted device.

20. The computer-readable storage medium of claim 18, wherein the hosted business service further provides an online collaboration service associated with the visualization.
